(19) United States
(12) Patent Application Publication
(10) Pub. No.: US 2024/0361427 A1
(43) Pub. Date: Oct. 31, 2024

(54) Test accumulative pulse radar warning system for hypersonic and supersonic aircraft

(71) Applicant: VIETTEL GROUP, Ha Noi City (VN)

(72) Inventors: DINH PHONG VUONG, Ha Noi City (VN); NHU DAN VO, Ha Noi City (VN)

(73) Assignee: VIETTEL GROUP, Ha Noi City (VN)

(21) Appl. No.: 18/625,595

(22) Filed: Apr. 3, 2024

(30) Foreign Application Priority Data
Apr. 27, 2023 (VN) 1-2023-02839

(51) Int. Cl. G01S 7/292; G01S 7/03; G01S 13/933

(52) U.S. Cl. CPC G01S 7/2927; G01S 7/03; G01S 13/933

(57) ABSTRACT

A Pulse Signal Accumulation System for determining target proximity in supersonic and ultrasonic flying devices comprises the following components: digital processing block, high-frequency transceiver block, power supply block, antenna block, and communication block. The system is designed to accurately determine and provide alerts for the presence of targets within the influence zone of unmanned aerial vehicles (UAVs) operating at supersonic or ultrasonic speeds, enabling appropriate actions to be taken by the UAVs. Additionally, the system is equipped with self-checking and monitoring capabilities for the individual components within the overall system.

### REFERENCE

The invention refers to a system for accumulating pulse signals for target proximity warning in the flight region of supersonic and ultrasonic flying devices. Specifically, the invention proposes a warning sensor system for unmanned aerial vehicles and targets approaching airspace with potential mutual interference, designed for use in supersonic and ultrasonic unmanned aerial vehicles (UAVs)

### TECHNICAL FIELD OF INVENTION

Accurately determining the timing of entry into the combat zone for supersonic and ultrasonic unmanned aerial vehicles (UAVs) is crucial for increasing the probability of successful engagement or executing effective strategies against various targets, given the high velocities of the UAVs. For high-speed supersonic and ultrasonic aircraft, precise timing requirements are stringent to ensure that the critical time window when the UAV and the target have significant potential for mutual impact is not missed.

Patent CN115394126A published Nov. 25, 2022:”

Method and apparatus for early collision warning in space targets. In the content of the invention, the author presents a method and apparatus for early collision warning in space based on the motion trajectories and states of two entities in space. This method is applied to avoid collisions between new and existing satellites in orbit due to the increasing presence of artificial devices in space. The objective of this invention is to provide early collision warning between two flying entities occupying the same vicinity in space and to determine the timing of the highest probability or greatest impact of collision for the warning system-equipped aircraft, without requiring knowledge of the current state of the other flying entity. The collision zone typically occurs within the atmosphere layer. In essence, no prior invention has addressed this issue.

### SUMMARY OF THE INVENTION

The invention comprises the construction of a pulse signal accumulation system for supersonic and ultrasonic UAVs to provide warning of detection or proximity to targets in space. The system has the capability to determine and alert the relative state of the UAV with respect to the target in space. To achieve the stated objective, the construction of the pulse signal accumulation system consists of functional blocks: antenna block, high-frequency transceiver block comprising a receiver and a transmitter, digital processing block, power supply block, and communication block.

Specifically, the antenna block includes a receiving antenna and a transmitting antenna, which play the role of converting high-frequency signals from the transmitter into high-frequency energy and radiating it into space, as well as converting the received high-frequency energy from space into high-frequency signals supplied to the receiver.

The high-frequency transceiver block includes:
Receiver: receives high-frequency signals from the receiving antenna, amplifies them, converts them to intermediate frequency, demodulates them, and sends them to the digital processing block.
Transmitter: generates high-frequency signals, amplifies them, and sends them to the transmitting antenna.

The digital processing block receives the demodulated signals from the receiver, accumulates them, and generates target proximity warning signals for the communication block. It also receives control commands from the communication block and generates synchronized pulses to control the entire operation of the receiver and transmitter.

The power supply block receives 115 V, 1000 Hz power source and converts it into DC power supply for the operation of the entire device.

The communication block receives and transfers control information from the UAV to the digital processing block. It also receives pulse signal warning information from the digital processing block and generates electrical signal pulses to notify the UAV when a target has entered the influence zone.

In this invention, the pulse accumulation system will determine the influence zone by accumulating reflected pulses from the target.

### BRIEF DESCRIPTION OF THE DRAWINGS

FIG. 1 illustrates the schematic diagram of the pulse signal accumulation system for warning of proximity to targets in space for supersonic and ultrasonic flying devices.

### DETAILED DESCRIPTION OF THE SYSTEM

The invention described in detail below is based on the accompanying drawing, which is intended to illustrate the options of the invention without limiting the scope of patent protection.

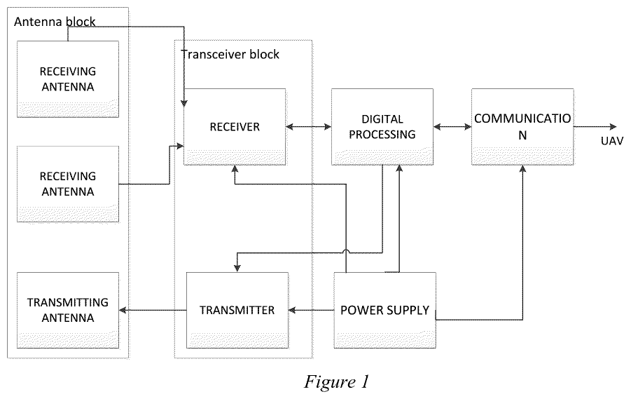

In particular, referencing FIG. 1, the pulse accumulation system for warning of target approaches to hypersonic and supersonic aircraft consists of functional blocks: digital processing block, communication block, power block, high-frequency transceiver block and antenna block including receiving and transmitting antenna. In which:

The numerical processing unit is responsible for receiving control commands from the communication block and creating synchronous pulses, controlling the entire operation of the receiver and transmitter, and at the same time receiving the following signal separating waves from the receiver, accumulating and creating warning signals approaching the target to the communication block. More specifically, the digital processing block is in charge of monitoring the status of the entire equipment, controlling the high-frequency transceiver block, controlling the operation cycle according to the set scenario, accumulating pulses that meet the conditions of meeting the target detection and packaging to send messages to the communication block. Meeting altitude processing speeds, error requirements and equipment condition alerts for UAV.

The communication block is the information bridge between the digital processing block and the UAV. More specifically, in the communication block: the port transmits control information from the UAV into the digital processing block so that the processing block operates in accordance with the scenarios and purposes of the UAV for each specific target case; Receiving a signaling pulse from the digital processing block when the digital processing block determines the algorithm that has ensured the target has entered the zone of influence.

The power block has the function of powering other blocks according to design requirements, ensuring military and aviation standards. The power block receiving 115 V 1000 Hz power is converted into DC power, supplied to other blocks depending on the input requirements of each block, the power block of the system meets MIL-STD-416 and MIL-STD-704F military standards. The source used is an isolation source to ensure that mid-frequency signals, communication signals are not subject to electromagnetic interference.

The high-frequency transceiver block has the function of receiving high-frequency signals from the receiving antenna, amplifying, transferring to the middle frequency, splitting the waves and feeding them into the digital processing block, creating high-frequency signals, amplifying and delivering them to the transmitting antenna. More specifically, a high-frequency transceiver block is a block responsible for generating high-frequency modulation signals and emitting them into space, while also receiving signals from space and comparing the returned signal with the target assurance threshold level in the required area. The block also includes attenuation circuits to control the receiver/transmitter signal in accordance with the operation of the warning radio pulse accumulator system under different circumstances.

The antenna block is responsible for emitting high-frequency signals into space and receiving, ensuring that the coverage area covers the entire target viewing area of the UAV. More specifically, the antenna block is the block responsible for radiating pulse signals into space and collecting them for the separation of the contour of the receiver, the coordination position and orientation diagram of the two antennas towards the UAV to ensure the spatial observation of the UAV for the complete target area.

With the above structure, the pulse accumulation system system for warning of approaching the target has the function of determining whether the relative instantaneous state of the aircraft and the target is already in the zone of mutual influence. The pulse accumulator system for warning is capable of stable operation, withstanding large accelerations and electromagnetic interference on other components of the flight aircraft according to MIL-STD-704F and MIL-STD-461 standards.

The principle of operation of the system: The system uses an extremely short pulse transmitter to generate a pulse signal emitted into space, the pulse signal is regulated by attenuators, noise filtering, mixing to the high frequency and amplifying at the transmitter to give the transmitting antenna. Depending on the target monitoring zone, the pulse length and pulse broadcast cycle will be changed accordingly, the control of this parameter is carried out by the digital processing system. This high-frequency radio pulse signal when encountering flying objects in the observation area will reflect back and be collected through the antenna system, to ensure the full observation of the space area, the system will receive the signals of two receiving antennas in turn in a cycle, The arrangement of two receiving antennas ensures that the entire viewing area in the direction of flight of the UAV is covered and still ensures the aerodynamic properties of the UAV in conditions of transonic and supersonic speeds. The pulse signal obtained from the antenna will be extracted by the contour splitter to extract the signal from the carrier and compared with a threshold level that changes flexibly according to information from UAV, the broadcast time, signal reception, threshold level and algorithm to determine the zone and touch depend on the status of the UAV, the purpose of the UAV's approach to other flying objects and the target's information if any. When the pulses collected beyond the threshold are accumulated enough to meet the specified condition that the original goal of the UAV has been achieved, the system sends a signal informing the UAV that the target has fallen into the affected area.

### ACHIEVED RESULT

The pulse accumulation system for warning of approaching the target described by this invention is capable of accurate and reliable operation, giving accurate warning of the relative position of the aircraft and the target. The system also monitors the operation of subcomponents of the system, thereby assessing and issuing warnings for abnormal conditions for the aircraft.

Although the above descriptions contain many specifics, they are not considered limited to patent enforcement, but only serve to illustrate some preferred enforcement options.

1. A pulse signal accumulation system for determining target proximity in supersonic and ultrasonic flying devices, comprising:
a digital processing block that receives demodulated signals after wave separation from a receiver, accumulates the demodulated signals, and generates target proximity warning signals to a communication block, and also receives control commands from the communication block and generates synchronized pulses to control the entire operation of the receiver and a transmitter;
a high-frequency transceiver block that comprises signal generation and reception circuits, envelope wave separation circuits, comparison and alerting circuits, a high-frequency signal is transmitted as narrow-width single pulses through a transmitting antenna, while the received signal is wave-separated and compared against an adaptive threshold for target detection within a coverage area;
a power supply block responsible for voltage transformation suitable for each of a signal circuit, ensuring isolation from other signals and complying with military and aviation standards;
an antenna block that radiates high-frequency signals into space and receives them back, comprising a set of independent transmitting and receiving antennas, with directional patterns and arrangements on the flying device to observe an entire forward space along a direction of movement; and
a communication block providing a transmission channel for control information from the flying device to the digital processing block and also receiving pulse signal indications from the digital processing block when an algorithm ensures that the target has entered the influence zone.
